(19) United States
(12) Patent Application Publication
(10) Pub. No.: US 2008/0141091 A1
(43) Pub. Date: Jun. 12, 2008

(54) Method and Apparatus for Recovering From Errors in Transmission of Encoded Video Over a Local Area Network

(75) Inventor: Rama Kalluri, Lexington, MA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/567,368

(22) Filed: Dec. 6, 2006

(51) Int. Cl. H04L 1/08; G06F 11/14

(52) U.S. Cl. 714/748; 714/E11.113

(57) ABSTRACT

A video communication arrangement includes a transmitter for transmitting a digitally encoded video stream to a receiver associated with a video rendering device. The digitally encoded video stream including a plurality of frames. The arrangement also includes a frame locator for identifying locations from which the frames are available for retrieval and a signal analysis system for analyzing a return signal received from the receiver to determine if a degraded signal condition exists between the transmitter and receiver sufficient to cause improper reception by the receiver. A recovery system is provided for retrieving at least one replacement frame if the degraded signal condition exists and for causing the replacement frame to be re-transmitted to the receiver.

### FIELD OF THE INVENTION

The present invention relates generally to the transmission of encoded video data, and more particularly to a system and method of recovering from transmission loss of encoded video data over a local area network such as a home network.

### BACKGROUND OF THE INVENTION

The number of home networks has been growing rapidly. The prices of personal computers and networking devices have come down significantly and it is relatively easy for a household with multiple computers to set up a home network. As a result, computer networking is no longer limited to work places and has entered many homes.

FIG. 1 shows a home network 70 that is integrated with home entertainment components. The home network 70 may be built on an IP-based Ethernet network 104. In the example illustrated in FIG. 1, the home network 70 connects devices for work and entertainment functions. For instance, a productivity station 72, which may be located in the study room of the house, includes a desktop personal computer 74 that may be connected to the home network via wired or wireless connections. An entertainment center 76, which may be located in the family room, contains video/audio equipment including a display device (e.g., television) 82. As described in greater detail below, the display device 82 has a media client 86 that provides connectivity to the home network 70. Another display device 84, which may be located in the bedroom, is also connected to the home network 70 by media client 88. In some examples the home network 70 is a wired network, a wireless network or part wireless and part wireless network. To that end, the home network 70 includes one (or more) wireless access points (WAP) 96 that functions as the base station for a wireless local area network (LAN) and is typically plugged into an Ethernet hub or server. In addition to providing connectivity to the aforementioned devices, a wireless LAN may be especially suitable for portable devices such as a notebook computer 90, a tablet PC 92, and a PDA 94, for example.

The home network 70 includes a media center or server 100. The media server may be located, for instance, in an equipment room. The media server 100 may be implemented as a general-purpose computer. Alternatively, the media server 100 may be a dedicated microprocessor-based device, similar to a set-top box, with adequate hardware and software implementing media service related functions. The media server 100 includes a tuner 102 to connect it to various video/audio signal sources. The tuner 102 may receive signals from different carries such as satellite, terrestrial, or cable (broadband) connections. The media server 100 may be provided with capabilities to access the Internet 110. In the illustrated example, the media server 100 is connected to an Internet gateway device (IGD) 106, which may be connected to the Internet via a cable or phone line (i.e., publicly switched telephone network (PSTN)). In the illustrated example, the Internet gateway device 106 is also used by the personal computer 74 in the productivity station 72 to access the Internet 110.

Any network, such as home network 70, particularly if it is a wireless network, is subject to transmission errors. For example, a fading condition may occur when interference from an electrical appliance, for instance, degrades or disrupts transmission between a transmitter (e.g., the media center) and a receiver (e.g., the media client). Often, such communication errors are severe enough to cause many bits of data to be lost (referred to as “burst bit errors”). If an encoded video stream is being transmitted, these errors may result in one or more frames of video data being lost. Unfortunately, in typical encoded video applications, such errors may not only cause the receiving device to miss the lost frame, but may also result in the loss of subsequent frames of video data, even if the subsequent frames were received intact. This loss of additional video frames occurs because in many video encoding schemes the frames are encoded using interdependencies among frames so that a loss of one frame may result in the loss of a subsequent frame that required data from the previous frame.

Accordingly, given the interdependent nature of encoded video streams, it would be desirable to provide a method and apparatus for efficiently recovering lost encoded video frames transmitted over a communications network

### BRIEF DESCRIPTION OF THE DRAWINGS

FIG. 1 shows a home network that is integrated with home entertainment components.

FIG. 2 shows the sequence headers in an illustrative MPEG digital video transport stream.

FIG. 3 shows an example of indexing a sequence header identifier with a sequence header location.

FIG. 4 shows an example of indexing the frames in a digital video stream with the sequence header identifier.

FIG. 5 is an example of a media server.

FIG. 6 shows one example of a database that may be prepared and maintained by the recovery system shown in FIG. 5.

FIG. 7 is a flowchart illustrating one process that may be employed to recover from transmission errors between a media server and a media client.

### DETAILED DESCRIPTION

Described below is a method and apparatus for reducing the adverse affects on the image quality of a digitally encoded video stream that arise from transmission errors. For purposes of illustration only the digitally encoded video stream will be described as an MPEG stream. However, the techniques described herein are more generally applicable to a digitally encoded video stream that conforms to any appropriate standard.

One common compression standard currently used for digital video streams is known as MPEG. MPEG is a standard for digitally encoding moving pictures and interleaved audio signals. MPEG facilitates compressing a video stream to reduce the storage capacity and transmission bandwidth required for an MPEG stream as compared to an uncompressed video stream.

The MPEG standard defines three types of frame formats: Intra-coded reference frames (I), Predictive-coded frames (P), and Bi-directionally predictive-coded frames (B). I frames contain all of the information required for a single video frame and are thus independent frames that need no information from other frames either before or after for decoding. On the other hand, P frames are defined with respect to preceding I frames or other P frames. B frames are bi-directionally defined with respect to both preceding and subsequent frames in the MPEG stream. Thus, both P and B frames need information from surrounding frames for decoding; a P or B frame by itself cannot be decoded into a viewable image. The I-, P-, and B-frames are organized into at least one sequence defined by a sequence header and a set of subsequent I, P, and B frames. The sequence header contains display initialization information defining picture size and aspect ratio, frames and bit rate, decoder buffer size, and chroma pixel structure and may contain optional quantizer matrices and/or user data.

As previously mentioned, transmission errors are virtually inevitable in a home network, particularly in a wireless network. Because of the interdependencies among MPEG encoded frames such errors may not only cause the receiving device to miss the lost frame, but may also result in the loss of subsequent frames of video data, even if the subsequent frames were received intact. For instance, if a predictive frame (e.g., a P frame) is lost, any subsequent frame that is directly or indirectly dependent on that lost frame cannot be decoded, and therefore would also be lost. Thus, if a P frame is lost during transmission to the receiver, all subsequent P frames received up to the next I frame will not be decodable. Given the fact that P frames typically occur in chains, a high likelihood for losing multiple P frames exists. Depending on the length of the chain of P frames, the amount of lost video frame data could be quite extensive.

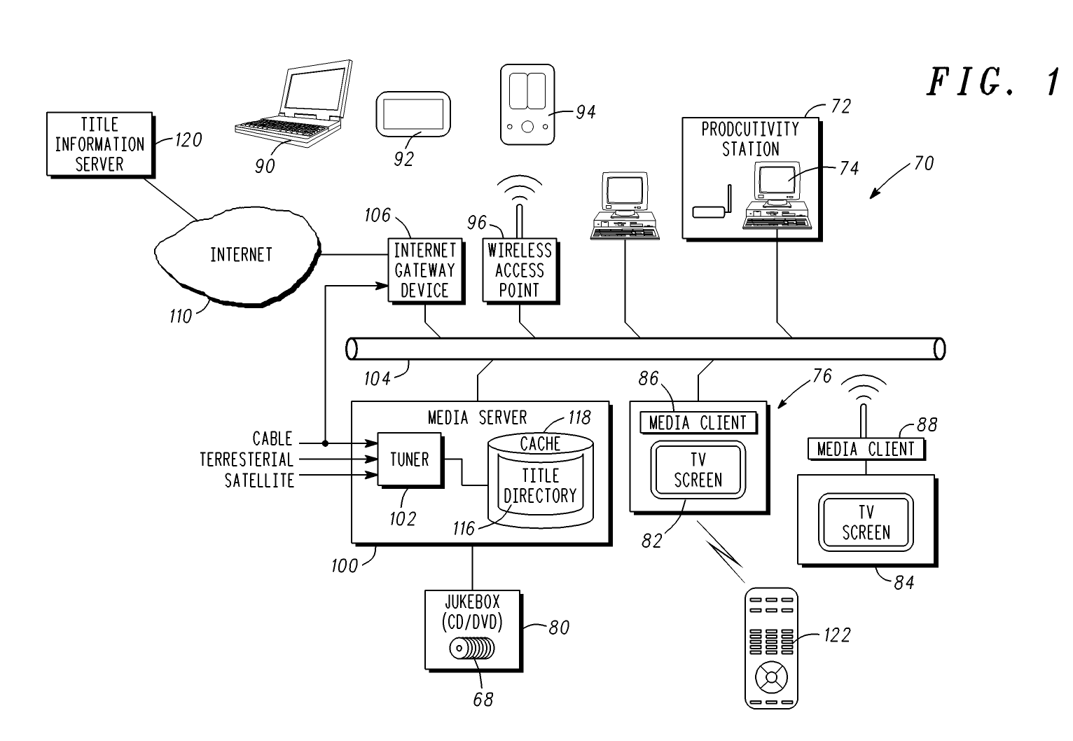

In the illustrative home network 70 shown in FIG. 1, to recover lost data sent from the media server 100 to one or more of the media clients, the media client must inform media server 100 that a loss condition has arisen. In response to receiving notification of a loss condition, the media server 100 needs to replace the lost data. However, given the interdependent nature of encoded video frames, determining the information that should be re-sent to efficiently recover lost video data can be problematic. For instance, as noted above, if a P frame of video data is lost during transmission to a media client, then all subsequent P frames cannot be decoded by the media client until the next I frame is received. The media client would therefore have to discard all of these subsequent P frames.

To overcome this problem in an efficient manner, upon detection of a loss condition by the media server 100, the media server 100 automatically transmits a replacement frame to compensate for the lost frame. This replacement ensures that an entire chain of P frames will not be lost. To resend or replace the appropriate frame or frames requires the media server to locate the appropriate frame or frames to be resent. This can be accomplished using indexing techniques that are often employed in non-standard or so-called trick play modes of display. However, such indexing techniques have not been used to provide error correction or to recover from transmission loss.

While digital video encoding and compression schemes reduce the storage and transmission bandwidth required for these digital video streams, they also result in video data that is not readily adaptable to non-standard modes of display. For example, viewers of video images like to be able to use trick play modes of viewing, which include by way of example: fast forward, reverse play, skip ahead, skip back, etc., which are functions that in many cases mimic functions of analog video tape recorders. As previously noted, since compressed video streams have inter-frame dependencies they are not readily suited to random access of different frames within the stream as is often required for trick play modes of viewing. To locate the desired frames during trick play modes of operation, an indexing scheme is employed, an example of which will be discussed below in connection with an MPEG compliant digital video transport stream.

In MPEG, sequence headers are often employed to provide certain data used for decoding and presentation of a video image as well as to facilitate the provision of trick play modes. Other video formats may utilize similar headers. Equivalent or similar headers used in other video formats will be considered sequence headers for purposes of the present discussion. MPEG sequence headers provide information such as image height and width, color space, frame rate, frame size, etc. A single sequence header could be used as the header for numerous frames, even an entire program in some cases. However, the sequence header is generally repeated on a relatively frequent basis such as at each MPEG I frame, for example.

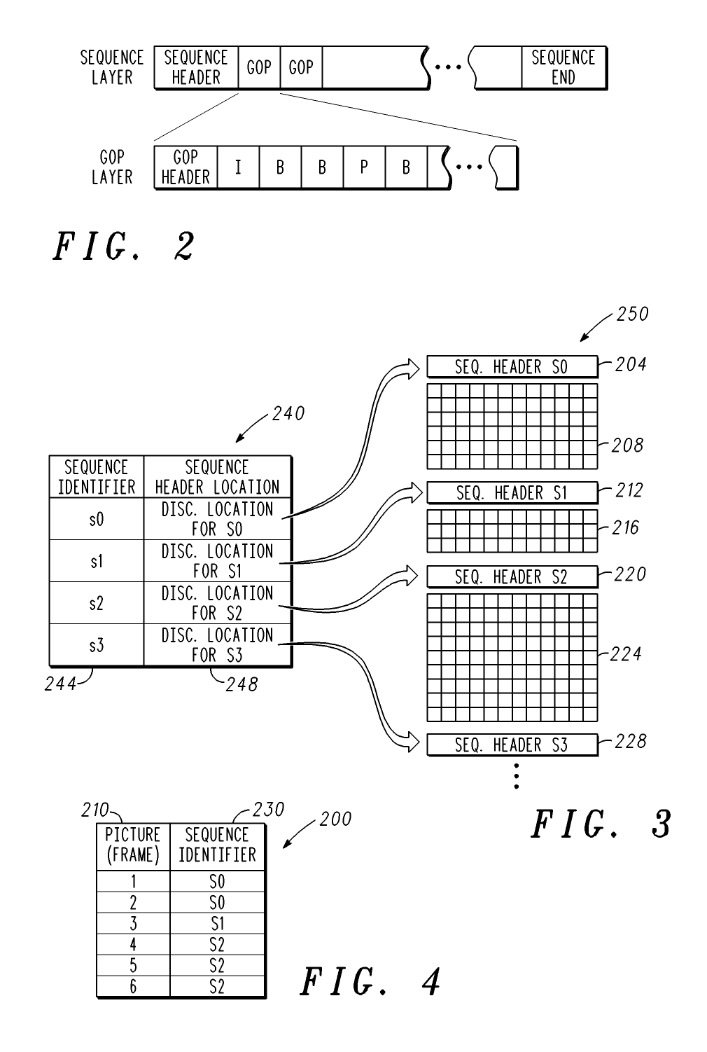

FIG. 2 shows the sequence headers in an illustrative MPEG digital video transport stream. Typically, the succession of frames comprising such a video sequence is divided for convenience into groups of frames or groups of pictures (GOP). The MPEG standard defines a sequence layer and a GOP layer. The sequence layer begins with a sequence header and ends with a sequence end. The sequence layer comprises more than one GOP. The GOP layer begins with a GOP header and comprises a plurality of pictures or frames. The first frame is generally an I-picture, followed by a P-picture and a B-picture. MPEG provides flexibility as to the use, size, and make up of the GOP, but a 12-frame GOP is typical for a 25 frames per second system frame rate and a 15-frame GOP is typical for a 30 frames per second system.

In trick play applications, the user could easily jump from one frame of video that operates according to a first sequence header to a frame of video that is part of a different video sequence, and thus requires a different set of sequence header data in order for the decoder to properly operate. If this happens, either the decoder will fail to properly decode the new frame or substantial delays in presentation of the image may occur while the video decoder searches for the proper sequence header.

Turning now to FIG. 3, this problem is often addressed by use of an indexing system (shown in an illustrative form in the figure) to assure that the decoder can always rapidly find the appropriate sequence header for a particular frame of video. A particular set of data that represents a video data stream can be visualized as a stream 250 stored in a file on the storage medium. Forward time movement is shown from top to bottom. This stream, in the portion shown, has a first sequence header 204 identified as S0, which provides information for sequence 208, which for purposes of illustration only will be assumed to be a series of GOPs. Sequence header 212 (S1), provides information for sequence 216. Sequence header 220 (S2), provides information for sequence 224. Sequence header 228 (S3), provides information for a subsequent sequence (not shown). By way of example, sequence header 204 may be repeated a number of times within sequence 208 to more readily facilitate random access, or it may be the only sequence header provided for this sequence.

In order to provide rapid access to the appropriate sequence header data for use in trick play modes of operation, each unique sequence header is indexed in an index table to a sequence header identifier. FIG. 3 shows an example of such an index table 240. In the index table 240, the sequence identifier is stored in column 244 and a disk location for the sequence header information is stored in column 248. Thus, for sequence 208, having sequence data in sequence number 204, a sequence identifier of s0 can be assigned that identifies a location on the disk drive of the media server where the data associated with sequence header 204 is stored. This location, for example, can be specified by an absolute address or by an offset from a reference address. In this manner, as soon as a proper sequence header is identified, its data can be retrieved rapidly in order to process a particular frame (picture) or collection of frames (pictures).

FIG. 4 shows an example of a further indexing table 200 that is used in conjunction with index 240 (or alternatively, the two tables can be combined or otherwise related). In this table 200, each picture in the stream 250 is indexed to a sequence identifier, with the picture (e.g., any I, P or B frame) or frame identifier stored in column 210 and the sequence identifier stored in column 230. In this example, the first two frames (pictures 1 and 2) are indexed to sequence identifier s0. Picture 3 is indexed to s 1; and pictures 4, 5 and 6 are indexed to sequence identifier s2. Thus, using this index, a picture to be displayed (e.g., after the user initiates a jump in frames, as for example, in a trick mode) can be quickly associated first with a sequence identifier and then with an appropriate set of data from a sequence header via the sequence identifier. Alternatively, the sequence identifier can be integrated with the frame data or group of pictures (GOP) data for storage so that each frame or GOP is self-associated with the sequence identifier.

Some or all of the information incorporated in the index tables shown in FIGS. 3 and 4 may be located in a System Table that is available in the system or control layer of the MPEG transport stream. Since the index tables shown in FIGS. 3 and 4 are available (either directly from tables in the transport stream 250 or derivable from information in the transport stream) for purposes of implementing trick play modes of display, the same tables can be used to resend information that is not properly received by a media client from a media server because of a loss condition. FIG. 5 shows a functional block diagram of the media server 100 of FIG. 1 to illustrate how the media server uses the index information to recover from the loss condition.

Also shown in FIG. 5 is a representative media client 95, such as clients 86 and 88 in FIG. 1. The media client may be built into the display device set, as in the case of the television 82 in FIG. 1. Alternatively, the media client may be an outboard device, such as a set-top box, which drives conventional televisions with digital and/or analog video/audio signals, as in the case of the television 84 in FIG. 1. The media client 95 is programmed to present interactive user interface screens to the user. On any display device that has a media client device connected to the home network 70, a user can select digital information obtained from media server 100 for viewing on the display device. The media clients include a video decoder/decrypter 97 for decoding the tuned digital signal (e.g. an MPEG-2 television signal) prior to sending it to their respective display devices. The decoder/decrypters may also include decryption circuitry that decrypt encrypted content from the content feed.

It should be emphasized that media server 100 shown in FIGS. 1 and 5 is only one example of a media server and is presented by way of illustration only. Those skilled in the art will appreciate that the media server can be structured differently from that illustrated, and can include more or fewer of the components than shown in FIG. 5. The media server 100 may offer, for instance, digital video, audio, and high speed-data services along with streaming media, PPV, Internet services, HDTV, and personal video recorder (PVR) capabilities. Moreover, the media server may be associated with, or provide the functionality of, any one or more of the following: a television, a tuner, a receiver, a set-top box, and/or a Digital Video Recorder (DVR). The media server may comprise one or many devices, each of which may have fewer or more components than described herein. Similarly, the media server may be a component or attachment of another device having functionality that may differ from that provided by the media server.

In some cases certain of the devices referred to above that may be associated with media server 100 alternatively may be distributed among other devices in the home network such as the media client. Likewise, additional functionality not depicted in the media server of FIG. 5 may be transferred from the media client to the media server. Regardless of the various features and functionality that it offers, an important aspect of the media server is that it is a centrally located means for storing programs that are readily and contemporaneously accessible by, and readily and contemporaneously controllable by, multiple local client devices via the home network.

The components of the media server 100 discussed below may all operate under the control of a processor 58. It should be noted that the processor 58 and other components of the media server may each be implemented in hardware, software or a combination thereof In addition, although the various components are shown as separate processors, it is contemplated that they may be combined and implemented as separate processes on one or more processors.

As shown, media server 100 includes a digital tuner 46 for tuning to a desired digital television channel from the band of television signals received by the set-top 100 via input 34 (e.g., the cable, terrestrial and satellite broadband connections shown in FIG. 1) and user interface 60. While not shown in FIG. 5, it will be recognized that the digital set-top terminal 100 will generally also include an analog tuner to decode and display analog video. A multimedia processor 50 communicates with the digital tuner 46. The multimedia processor 50 may perform any necessary encoding and decoding and thus may include, for example, an MPEG encoder/decoder.

A storage medium 106 is connected to the multimedia processor 50 as well as the processor 58. The storage medium 106 may include one or more hard disk drives and/or other types of storage devices including solid state memory devices such as chips, cards, or sticks. The storage medium 106 may also include magnetic tape, magnetic or optical disk, and the like. The multimedia processor 50 routes the content received from the broadband connection to the storage medium 106 if the content is to be recorded. The multimedia processor 50 also routes the content received from the broadband connection to the media clients associated with the various display devices if the content is to be rendered in real time. If the content is to be rendered at a later time, the multimedia processor 50 routes the content from the storage medium 106 to the media clients.

A frame and sequence header indexer 62 receives the encoded video stream from the digital tuner 46 before it is forwarded to the multimedia processor 50. The indexer 62 monitors the video stream and either acquires the information shown in FIGS. 3 and 4 directly from the video stream (e.g., from an MPEG System Table) or generates the index tables, which are then stored on the storage medium 106. If the information is available directly from the video stream or is otherwise already available, the functionality of the frame and sequence header 62 may be performed by a simple frame locator that identifies the location of the frames. In this case the functionality of the frame locator may be performed in the MPEG encoder/decoder or the like that is generally associated with the multimedia processor 50. Regardless of how the information is acquired, the data stream is stored along with the information needed to permit rapid retrieval of the appropriate sequence header (or the data from the sequence header) and the appropriate frames or frames identified by the sequence header.

A recovery system 170 is provided to identify a loss condition between the media server 100 and a media client 95, to locate the appropriate frames on the storage medium 106 that will need to be re-sent, and cause the appropriate frames to be re-sent to the media client 95. As shown, while the encoded video stream is being transmitted to the media client 95 by the multimedia processor 50, the recovery system 170 receives a return signal from the media client 95. The return signal may be any type of signal that informs the media server 100 of the signal condition between the media client 95 and the media server 100. For instance, the media client 95 could repetitively transmit a code or sequence of bits that would continuously inform the media server 100 of the state of the communication link. Alternatively, the return signal could comprise an error message that would be sent any time the media client 95 failed to receive a signal from the media server 100 or anytime the media client 95 identified an error during the course of performing error correction, using, for example, a cyclic redundancy check (CRC). In yet another case involving a continuous two-way video communication, the return signal could comprise or be embedded in video data being transmitted back to media server 100. If the individual frames of the video data are sequentially numbered, errors may also be detected by counting the frames and identifying any that may be missing (e.g., if frames 5 and 8-10 are received, then frames 6-7 were presumably not properly received).

Once received, the recovery system 170 analyzes the return signal to determine if a loss condition exists between the media server and media client. A loss condition may be detected as a lost signal, a degraded signal, a fading condition, erroneously received data, etc. In general, a degraded or fading signal condition is determined to exist if its signal strength is below that necessary for the signal to be successfully decoded by the media client or if the signal is otherwise unacceptable to the receiver (e.g., if the receiver is unable to read and process all the information therein). Another example of degraded signal is a signal that causes improper playback. The recovery system 170 can make its determination based on any criteria, e.g., if the return signal power level falls below a predetermined threshold, if a return bit sequence is not received, etc. For instance, if a loss condition is detected for data being transmitted from media client 95 to the media server 100, the recovery system 170 may conclude that a loss condition also existed for data being transmitted from the media server 100 to media client 95. Based on this determination, the recovery system 170 can identify any frame or frames of data that were not received and/or properly decoded by the media client 95. Once the frame or frames are identified, their location can be determined from the indexing tables located on the storage medium 106. The recovery system 170 then instructs the multimedia processor 50 to resend those frames to the media client 95. That is, the recovery system 170 may resend the same frames that were lost. Alternatively, as mentioned earlier, the replacement frames that are forwarded may be I frames that are used to replace P or B frames that have been previously transmitted and which were presumably not adequately received because of the loss condition.

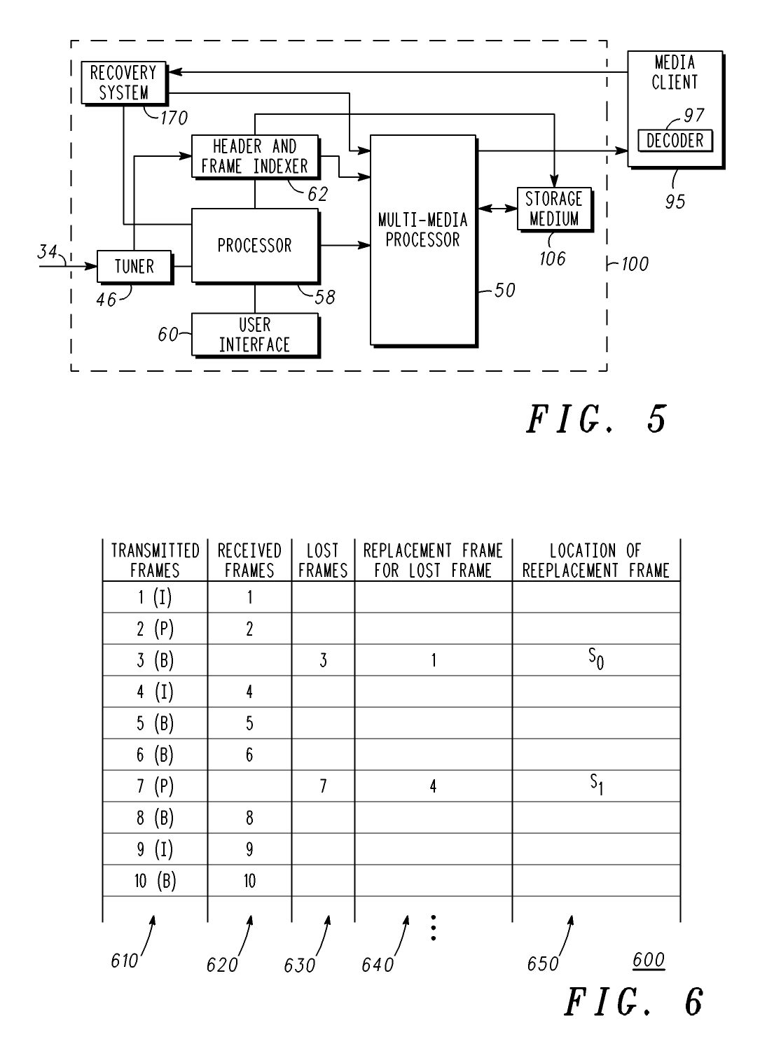

FIG. 6 shows one example of a database that may be prepared and maintained by the recovery system 170 to identify the frames that have been transmitted, successfully received and lost as well as the frames that need to be re-transmitted to replace the lost frames. This example assumes that a previously transmitted I frame is to be resent to replace the lost frame. Of course, if necessary or desired, all the intervening frames between the re-transmitted I frame and the lost frame may also be resent. Alternatively, all the frames associated with a particular grouping such as a sequence header or the like may be retransmitted. As shown, database 600 includes five columns of entries, one column 610 for identifying the frames that have been transmitted to the media client 97 by the multimedia processor 50, a second column 620 for identifying the frames successfully received by the media client 97 (as indicated, for example, by the acknowledgement signal sent from the media client to the media server 100), a third column 630 for identifying any frames that have been lost (also as indicated by receipt or lack of receipt of an acknowledgement signal), a fourth column 640 indicating the I frame that is to be retransmitted to compensate for the lost frame shown in the third column 630, and a fifth column 650 specifying the location from which the I frame is to be retrieved, either from the data stream itself or from a location on a storage medium. Depending on the particular application, database 600 may be additional or fewer columns of information. In FIG. 6 database 600 is populated with an illustrative series of 10 frames that have been transmitted to the media client 95. As the database 600 indicates, all but two frames (frames 3 and 7) were successfully received. Since frame 3 is a B frame and frame 7 is a P frame, the preceding I frame is retransmitted in both cases. That is, frame 1 is transmitted to replace frame 3 and frame 4 is retransmitted to replace frame 7. In this example the replacement frames are retrieved using the sequence identifier shown in column 650, which corresponds to the replacement frame.

As previously noted, the frames that are resent may be selected in a number of different ways and is not limited to the process depicted in FIG. 6. For example, instead of re-transmitting frame 1 to replace frame 3, the recovery system 170 may determine that it is unnecessary to send any replacement frames at all since the loss of a B frame may only impact the lost frame and not any subsequent frames. As another example, if frame 7 was lost, the recovery system may decide to simply resend frame 7.

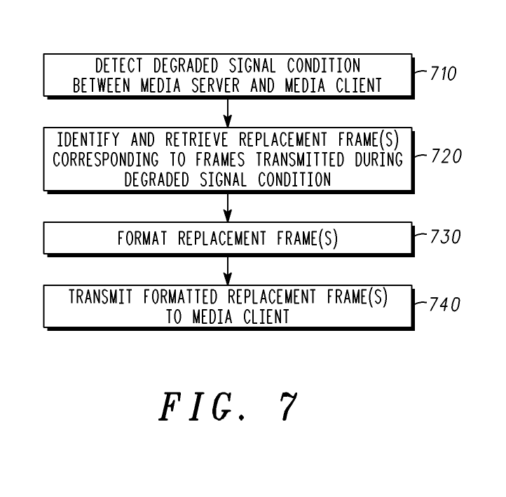

FIG. 7 is a flowchart illustrating one process that may be employed to recover from transmission errors between a media server and a media client. The process begins in step 710 when a degraded signal condition is detected by the media server, which prevents or is likely to prevent one or more frames from being properly received by the media client. A degraded signal condition may be said to exist based on any of the aforementioned criteria that may prevent the signal from being properly decoded by the media client. In step 720 one or more replacement frames are identified which correspond to the frame(s) that was transmitted while the loss condition existed. The replacement frame(s) corresponding to the lost frame(s) may be identified using the information available from database 600. The replacement frame(s) that has been identified is retrieved either from storage or from the video stream, once again using information available from database 600. If necessary, the replacement frame(s) may be formatted in step 730 so that it is suitable for transmission from the media server to the media client. For example, it may be necessary to packetize the replacement frame(s) prior to transmission. Finally, in step 740 the properly formatted replacement frame(s) is transmitted to the media client.

It should be noted that instead of retransmitting frames that have been lost, alternative groupings of data may be retransmitted. For instance, instead of a complete image in a video sequence, any of a variety of fields may be retransmitted that may be used with other types of data in which the fields are to be grouped together in a sequential or other fashion. For example, the fields that are sequenced may be some subset of a series of video or audio frames or a subset of sequentially arranged data structures or multimedia data.

The processes described such as those depicted in FIG. 7 may be implemented in a general, multi-purpose or single purpose processor. Such a processor will execute instructions, either at the assembly, compiled or machine-level, to perform that process. Those instructions can be written by one of ordinary skill in the art following the description of provided above and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

It will furthermore be apparent that other and further forms of the invention, and embodiments other than the specific embodiments described above, may be devised without departing from the spirit and scope of the appended claims and their equivalents, and it is therefore intended that the scope of this invention will only be governed by the following claims and their equivalents.

1. A video communication arrangement, comprising:
a transmitter for transmitting a digitally encoded video stream to a receiver associated with a video rendering device, said digitally encoded video stream including a plurality of frames;
a frame locator for identifying locations from which the frames are available for retrieval;
a signal analysis system for analyzing a return signal received from the receiver to determine if a degraded signal condition exists between the transmitter and receiver sufficient to cause improper reception by the receiver; and
a recovery system for retrieving at least one replacement frame if the degraded signal condition exists and causing the replacement frame to be re-transmitted to the receiver.

2. The video communication arrangement of claim 1 wherein the frame locator comprises a frame indexer for associating frames in the encoded video stream with the locations from which the frames are available for retrieval.

3. The video communication arrangement of claim 1 wherein the frame locator extracts the locations from information available in the data stream.

4. The video communication arrangement of claim 1 wherein the at least one replacement frame comprises an I frame.

5. The video communication arrangement of claim 4 wherein the replacement frame is the same as a frame that was lost while the degraded signal condition exists.

6. The video communication arrangement of claim 1 wherein the digitally encoded video stream conforms to an MPEG standard.

7. The video communication arrangement of claim 2 wherein the frame indexer associates the frames with sequence headers employed in the digitally encoded video stream and the sequence headers are further associated with locations from which the frames associated therewith can be retrieved.

8. The video communication arrangement of claim 1 wherein the degraded signal condition is determined to exist if a strength of the return signal is below a predetermined threshold.

9. The video communication arrangement of claim 1 wherein the degraded signal condition is determined to exist if the return signal includes an error message from the rendering device.

10. A media server for distributing digitally encoded video stream programs over a network to a media client, comprising:
a frame locator for identifying locations from which frames are available for retrieval;
a signal analysis system for analyzing a return signal from the media client to determine if a degraded signal condition exists over the network between the media server and the media client; and
a recovery system for retrieving at least one replacement frame from its available location if a degraded signal condition exists and causing the replacement frame to be re-transmitted to the media client.

11. The media server of claim 10 wherein the at least one replacement frame comprises an I frame.

12. The media server of claim 11 wherein the replacement frame is the same as a frame that was lost while the degraded signal condition exists.

13. The media server of claim 10 wherein the digitally encoded video stream conforms to an MPEG standard.

14. The media server of claim 10 wherein the frame locator comprises a frame indexer for associating frames in the digitally encoded video streams with locations from which the frames are available for replacement.

15. The media server of claim 14 wherein the frame indexer associates the frames with sequence headers employed in the digitally encoded video stream and the sequence headers are further associated with locations from which the frames associated therewith can be retrieved.

16. The media server of claim 10 wherein the degraded signal condition is determined to exist if a strength of the return signal is below a predetermined threshold.

17. The media server of claim 10 wherein the degraded signal condition is determined to exist if the return signal includes an error message from the rendering device.

18. At least one computer-readable medium encoded with instructions which, when executed by a processor, performs a method comprising:
identifying at least one frame of a digitally encoded video stream which was forwarded to a receiver during a degraded signal condition sufficient to cause improper reception by a receiver;
identifying a location from which at least one replacement frame is available for retrieval; and
retrieving the replacement frame from its available location if the degraded signal condition exists and causing the replacement frame to be re-transmitted to the receiver.

19. The computer-readable medium of claim 18 wherein the frame identifying includes analyzing a return signal received from the receiver to determine if the degraded signal condition exists between the transmitter and the receiver.

20. The computer-readable medium of claim 18 further comprising associating frames in the digitally encoded video streams with the locations from which the frames are available for replacement.
